(19) United States
(12) Patent Application Publication
(10) Pub. No.: US 2026/0288368 A1
(43) Pub. Date: Sep. 24, 2026

(54) Low-Precision Matrix-Vector Multiplication in Off-the-Shelf DRAM

(71) Applicant: Normal Computing Corporation, New York, NY (US)

(72) Inventors: Maxwell Aifer, New York, NY (US); Vassilios Kaxiras, Belmont, MA (US); Dmitri Saberi, Brooklyn, NY (US); Rajath Salegame, Naperville, IL (US); Peter Deaville, West Chester, PA (US); Patrick Coles, Rio Rancho, NM (US)

(73) Assignee: Normal Computing Corporation, New York, NY (US)

(21) Appl. No.: 19/573,541

(22) Filed: Mar. 20, 2026

Related U.S. Application Data
(60) Provisional application No. 63/775,170, filed on Mar. 20, 2025.

(51) Int. Cl. G06F 3/06; G06F 17/16

(52) U.S. Cl. CPC G06F 3/0655; G06F 3/0604; G06F 3/0673; G06F 17/16

(57) ABSTRACT

A computing system performs low-precision matrix-vector multiplication (MVM) using a DRAM module, or set of DRAM modules, controlled by a memory controller. The MVM is performed using stochastic arithmetic, where real-valued quantities are represented by random bits. The DRAM module is used to perform high-throughput accumulation, while scalar multiplication is achieved by copying random bits within DRAM, conditioned on random bits stored in the memory controller. The computing system may be configured to perform a sequence of MVMs, with intervening operations that may be nonlinear. In this configuration, the computing system may be used to efficiently run the unadjusted Langevin algorithm to sample from a probability distribution.

### CROSS-REFERENCE TO RELATED APPLICATION(S)

This application claims the priority benefit, under 35 U.S.C. 119 (e), of U.S. Application No. 63/775,170, filed Mar. 20, 2025, which is incorporated herein by reference in its entirety for all purposes.

### BACKGROUND

### Processing in COTS DRAM

Within the broader field of processing-in-memory (PIM), a relatively recent development has been the use of Dynamic Random Access Memory (DRAM) as a computing architecture. Various modifications to standard DRAM have been proposed to facilitate this. It is also possible to use unmodified commercial off-the-shelf (COTS) DRAM devices to perform operations such as copying, AND, and OR in memory, although this involves the use of nominally disallowed command sequences. Such operations rely on activating multiple rows of memory simultaneously by violating nominal timing constraints (specifically, by making the time intervals between consecutive commands shorter than is allowed). Generating true random numbers in DRAM relies on the instability of the bitline voltage when multiple rows are activated with an average stored voltage of V_{dd}/2. Quite recently, bulk bitwise accumulation has been demonstrated in DRAM, achieving state-of-the-art throughput for that primitive. This operation effectively counts the number of logical ones in a column of memory and formats the result as a binary number. The latter result is implemented using a majority-of-5 operation in COTS DRAM, which uses fractional DRAM values.

### Stochastic Computing

Stochastic computing is an approach to performing algebraic operations on real numbers that uses far fewer logic gates than an equivalent binary arithmetic circuit. In stochastic computing, a real number is represented by a Bernoulli random variable whose probability of being equal to 1 encodes the real number. Stochastic computing has been applied to accelerating matrix-vector multiplication (MVM) among many other primitive operations used in machine learning and other fields. This approach has an advantage in that it is more resilient to bit-flip errors than binary arithmetic; however, stochastic computing is poorly suited to applications demanding high precision arithmetic, as the number of samples scales exponentially with the desired accuracy.

### Low-Precision Langevin Sampling

The unadjusted Langevin process is a simple and widely used Monte Carlo process for sampling a distribution whose score can be evaluated efficiently. This process and its variants are broadly applicable in Bayesian inference tasks, especially for sampling Bayesian posteriors. The unadjusted Langevin process involves repeatedly updating a state vector by first adding a deterministically computed drift term and then adding a noise term. The computation of the drift term can be done at low precision, as the noise causes high-precision information to be lost anyway. This indicates that hardware specifically designed for efficient low-precision computation may be well-suited to Langevin-based sampling. Analog architectures have been proposed to accelerate Bayesian inference by mapping a Langevin equation to the physical dynamics of a circuit. However, to our knowledge, there has not yet been a proposal to design hardware making use of in-memory stochastic computing to accelerate the unadjusted Langevin process.

### SUMMARY

There are multiple emerging technical challenges that society is facing and will likely continue to face over the next several years, including:
Artificial Intelligence (AI) energy consumption: Computing hardware for AI is consuming massive amounts of energy;
Silicon complexity: As AI models are increasing in complexity, the complexity of the underlying silicon chips is also increasing;
Compute shortage: There is now a shortage of high-performance computing systems such that even top AI companies are struggling to get access to the computing resources that they desire;
Supply chain: The long and intricate supply chain for semiconductor devices increases exposure to unpredictable geopolitical circumstances; and
Hardware waste: The rapid expansion of compute capacity places stress on the systems used to disposing of old computing hardware.

Our technology addresses the AI energy crisis via processing-in-memory (PIM). PIM helps reduce energy costs incurred by the von Neumann bottleneck. It also addresses the silicon complexity crisis because DRAM is much simpler than standard hardware for AI, such as GPUs. Additionally, DRAM chips are very inexpensive compared to GPUs, with the cost of a single DRAM chip on the order of ten dollars, as opposed to thousands or tens of thousands of dollars for a single GPU. Moreover, the supply chain for DRAM modules is less exposed to changes in geopolitics than that of GPUs, given that DRAM manufacturing processes are generally less centralized. And repurposing used DRAM chips as computing devices should reduce the total amount of hardware waste significantly.

Previous implementations of PIM in COTS DRAM have focused on implementing deterministic arithmetic operations on binary-formatted numbers, such as integer addition and multiplication. However, because PIM involves utilizing DRAM in ways that violate DRAM interface protocols, such operations tend to be unreliable, as they may be affected by small variations in manufacturing. For binary-formatted numbers, such errors can be catastrophic when they affect high-significance bits. By focusing on low-precision stochastic processes, we circumvent this limitation and remain robust to small errors in computation. In fact, we can engineer the non-determinism of in-memory operations to our advantage, integrating true random number generation with computation entirely in memory.

The von Neumann bottleneck arises from the overhead incurred by transferring data between a memory device and a separate processor. For processes with a high arithmetic intensity (the ratio of operations to transferred data), PIM offers a significant advantage, as data no longer needs to be moved with each step of the computation because the memory device performs the computation. Consequently, our approach is particularly well suited to Monte Carlo sampling processes such as the unadjusted Langevin process. This process involves evolving a Markov process with no explicit time-dependence and may take many timesteps to converge to equilibrium. Therefore, the computation can have a very high arithmetic intensity, as it includes repeatedly performing the same operation using mostly the same inputs. As noted above, high arithmetic intensity implies that the process can be accelerated significantly by a PIM architecture. Moreover, the unadjusted Langevin process does not need high precision evaluation of the drift velocity, as noise is added in the state update. Therefore, an advantage should accrue from trading accuracy for speed, which is precisely the tradeoff exploited by our method.

The present technology includes a system for computing a matrix-vector multiplication (MVM) to low precision using DRAM and a memory controller. The memory controller may be implemented using a field-programmable gate array (FPGA). This system may also be used to compute a sequence of operations including both MVMs and intermediate operations between consecutive MVMs, which are computed by the memory controller. The intermediate operations may include nonlinear functions such as tanh, relu, gelu, softmax, and other activation functions. The system may be used for high-precision MVMs by averaging the result over several low-precision MVMs.

The system relies on stochastic computing concepts to efficiently perform an MVM. The MVM includes two basic sub-operations: scalar multiplication and scalar addition. To perform scalar multiplication, two random bits are used as the inputs to an AND gate. The output of the AND gate is a random bit whose average is equal to the product of the averages of the two inputs. In this way, a single AND operation can be used to perform scalar multiplication.

An AND may be achieved implicitly by performing a copy operation in DRAM, conditioned on a random bit that is stored in the memory controller. In an inventive system, random bits whose means are equal to the components of the vector x may be generated on the memory controller. Then, random bits whose means are equal to the elements of A are generated in DRAM. A subset of the rows in a DRAM subarray can be designated as the workspace. The workspace can be any subset of the rows in the DRAM subarray. Next, a row of the random bits representing elements of A is copied to the workspace if the corresponding bit representing an element of x is 1. The bits produced in the workspace have means equal to an element of x multiplied by a row of A. Finally, each column of the workspace may be summed using the bulk bitwise accumulation method. Alternatively, the OR of all bits in a column may be computed as an approximation to the sum of that column.

The system may be used as follows: first, the matrix A is written to a DRAM subarray in binary, as well as its negation ¬A. The matrix elements and their negations are written to the same subarray. This is accomplished by the memory controller, which sends write commands to the DRAM device. Then, the memory controller samples bits with probability equal to the elements of x. Next, stochastic number generation is done in DRAM by writing random bits to a workspace (a subset of rows in the same subarray) and then performing comparisons between the bits of A and the random bits. The stochastic numbers representing elements of A are copied to the workspace, conditioned on the random bits representing elements of x. Bulk bitwise accumulation is used to sum the bits in the workspace, and the result is read by the memory controller. This results in a sample of the estimator y of the MVM. The memory controller can take and average more samples to achieve higher accuracy. An additional operation may be performed on the estimator in the memory controller, and the result may then be used as the input vector x to another MVM. A collection of DRAM subarrays may be used to compose an arbitrary number of MVMs with intervening operations, and the intervening operations may be nonlinear. The intervening operations may include such nonlinear operations as tanh, relu, gelu, softmax, and other activation functions.

The inventive technology can be used to estimate a product of a matrix and a vector as follows with a memory controller and DRAM (e.g., DRAM configured to perform high-throughput accumulation). The memory controller generates samples of a first set of Bernoulli random variables whose probabilities are proportional to elements of the vector. The DRAM operably coupled to the memory controller stores the matrix (e.g., with a first column of the matrix in a first column of the DRAM) and generates samples of a second set of Bernoulli random variables whose probabilities are proportional to elements of the matrix. The memory controller directs the DRAM to copy the samples of the second set of Bernoulli random variables from a first portion of the DRAM to a second portion of the DRAM conditioned on the samples of the first set of Bernoulli random variables. The DRAM performs bulk bitwise accumulation on the second portion of the DRAM, and the memory controller reads an output of the bulk bitwise accumulation as an estimate of the product of the matrix and the vector. This entire procedure occurs without writing the vector to the DRAM.

The DRAM can generate the second set of Bernoulli random variables by comparing a binary representation of the elements of the matrix to a set of unbiased random bits.

The memory controller can generate a binary negation of the matrix and load that binary negation in the DRAM, which can use the binary negation in performing the bulk bitwise accumulation.

If desired, the memory controller and DRAM can make and average multiple estimates of the product of the matrix and the vector. For instance, the memory controller can generate samples of a third set of Bernoulli random variables whose probabilities are proportional to elements of the vector. Likewise, the DRAM can generate samples of a fourth set of Bernoulli random variables whose probabilities are proportional to elements of the matrix. In these cases, the memory controller copies the samples of the fourth set of Bernoulli random variables from one portion of the DRAM to another portion of the DRAM conditioned on the samples of the first set of Bernoulli random variables. The DRAM performs bulk bitwise accumulation on the other portion, and the memory controller reads an output of the bulk bitwise accumulation as a second estimate of the product of the matrix and the vector.

The memory controller and DRAM can also estimate products of the matrix with different vectors without copying those different vectors to the DRAM. To estimate the product of the matrix with a second vector, the memory controller generates samples of a third set of Bernoulli random variables whose probabilities are proportional to elements of the second vector. The DRAM generates samples of a fourth set of Bernoulli random variables whose probabilities are proportional to elements of the matrix. The memory controller instructs the DRAM to copy the samples of the fourth set of Bernoulli random variables from one portion of the DRAM to another portion of the DRAM conditioned on the samples of the third set of Bernoulli random variables. The DRAM performs bulk bitwise accumulation on the other portion of the DRAM. And the memory controller reads an output of the bulk bitwise accumulation as an estimate of the product of the matrix and the second vector.

The memory controller may also perform a nonlinear operation on (the estimate of) the product of the matrix and the vector.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a process for obtaining a sample of the estimator for the matrix-vector product.

FIG. 2 illustrates a communication loop between a DRAM module and a memory controller (e.g., an FPGA) in a stochastic computing system.

FIG. 3 illustrates schematically a set of three DRAM bitcells (memory cells) connected to the same bitline and sense amplifier.

### DETAILED DESCRIPTION

### MVM in DRAM

Consider the problem of matrix-vector multiplication (MVM). Suppose we are given an N×M real matrix A and a real vector x∈R^{N}, and would like to compute their product

$$y = {x}^{T} A . \qquad ( 1 )$$

We write the elements of A as aᵢⱼ, and we assume that aᵢⱼ∈[0,1] and xᵢ∈[0,1] for all i and j. This restriction should not diminish the applicability of the following method; the case where A and x have negative elements can be reduced to multiple instances of the problem under consideration, along with a small amount of postprocessing.

The elements of A are specified to w bits of precision, and we denote the kth most significant bit of a matrix element by aᵢⱼ[k], so

$${a}_{ij} = {\sum }_{k = 1}^{w} {a}_{ij} [ k ] {2}^{- k} . \qquad ( 3 )$$

With this encoding, the minimal value is 0 and the maximal value is aₘₐₓ=1-2^{-w}.

Our approach to evaluating the product in Eq. (1) is based on stochastic arithmetic, where a real number is mapped to a Bernoulli random variable. We use the notation Ber(x) for a Bernoulli random variable whose probability of being equal to one is:

$$Pr ( Ber ( x ) = 1 ) = x . \qquad ( 3 )$$

Now suppose we are given a, b∈[0,1], and transform them into independent Bernoulli random variables. We consider the Boolean AND of these two random bits, and see that

$$Ber ( a ) ⋂ Ber ( b ) = Ber ( ab ) , \qquad ( 4 )$$

or equivalently [symbol] Ber(a)∩Ber(b) [symbol] =ab, where [symbol] ⋅ [symbol] is the expected value. This suggests an approach to computing y by sampling Bernoulli random variables, applying AND gates, and then summing. Specifically, we define the random variables

$${\hat{y}}_{j} = {\sum }_{i = 1}^{N} Ber ( {a}_{ij} ) ⋂ Ber ( {x}_{i} ) . \qquad ( 5 )$$

Their means are

$$〈 {\hat{y}}_{j} 〉 = {\sum }_{i = 1}^{N} {a}_{ij} {x}_{i} , \qquad ( 6 )$$

which implies that

$$〈 \hat{y} 〉 = y . \qquad ( 7 )$$

Therefore, it is possible to obtain an estimate of y by:
1. Generating samples of Ber(aᵢⱼ) and Ber(xᵢ) for all i, j,
2. Evaluating the AND gate on the aᵢⱼ and the xᵢ samples, and
3. Summing over i.

Then, multiple samples of ŷ may be averaged to improve this estimate. This can be done in commercial DRAM in a highly parallel way, where each column of A is written to a column of a DRAM subarray (that is, a set of memory cells sharing the same bitline), and the jth element of ŷ is computed in the jth column of DRAM.

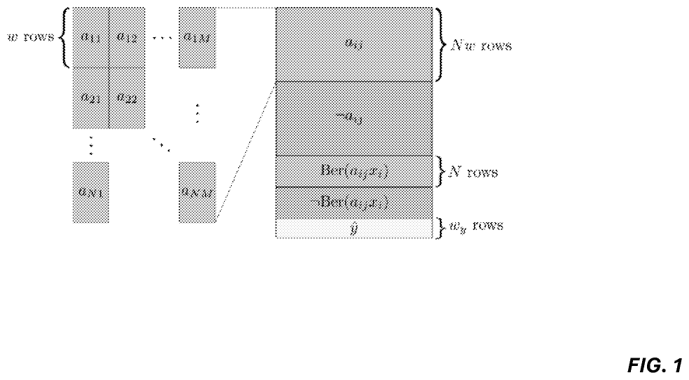

FIG. 1 illustrates a process of obtaining a sample of the estimator for the matrix-vector product. The elements aᵢⱼ of the matrix A can be written to a set of Nw DRAM rows in binary format (top right). The elements ¬aᵢⱼ of the binary negation of A can be written to a separate set of Nw DRAM rows (second from top, right). This may be done such that the ith column of A is written to the ith column of a DRAM subarray. Next, samples of the random variables Ber(aᵢⱼxᵢ) are generated, along with their negations ¬Ber(aᵢⱼxᵢ). The generation of the random variables Ber(aᵢⱼxᵢ) is accomplished on the DRAM device by first generating unbiased random bits on the memory controller and writing them to a workspace (subset of rows in the DRAM subarray), then comparing the matrix elements in the DRAM device to the random bits in the workspace to produce random variables Ber(aᵢⱼ) (this comparison can be done in DRAM using the following method). The generation of Ber(aᵢⱼ) is done only if Ber(xᵢ)=1, and otherwise the corresponding row of the workspace is left storing zeroes. The binary samples and their negations are respectively written to separate sets of N DRAM rows. Finally, bulk bitwise accumulation is performed on the stochastic samples and their negations to obtain a sample of the estimator ŷ.

While the elements of A are stored in binary in DRAM, the elements of x are never actually written to the subarray. The insight that allows for this is that the random bit Ber (aᵢⱼ)∩Ber(xᵢ) can be sampled using an operation conditioned on a sample of xᵢ produced off-DRAM. Suppose, for example, that a sample of Ber(aᵢⱼ) is present in row k. Then, off-DRAM, a sample of Ber(xᵢ) is generated, and if it is equal to 1, we copy the kth row into another row (row l, say). In row l, we now have a sample of Ber (aᵢⱼ)∩Ber(xᵢ), as desired. This description captures the main elements of our method. Our method can also use the negated samples ¬Ber(dᵢⱼxᵢ) to compute the sum in Eq. (5) even though NOT is not a native operation to DRAM.

We provide here a summary of the MVM process, and the following sections describe how to generate stochastic numbers in DRAM in greater detail.
1. Each matrix element aᵢⱼ is written to w consecutive DRAM cells in the same column, such that a column of A is mapped to a column of the subarray.
2. Off DRAM, a sample of Ber(xᵢ) is generated for each i. If Ber(xᵢ)=1, then on-DRAM, a sample of Ber(aᵢⱼ) is generated for all j. This results in samples of Ber(aᵢⱼxᵢ) for all i and j. As explained below, the generation of the sample of Ber(aᵢⱼ) is done by comparing the binary representation of aᵢⱼ to set of unbiased random bits. The negation of the generated sample is generated by comparing the negation of the binary representation of aᵢⱼ to the same set of unbiased random bits.
3. The samples of Ber (aᵢⱼxᵢ) are summed over i using bulk bitwise accumulation, resulting in a sample of the estimator ŷ
4. The above steps may be repeated to produce more samples of ŷ which are averaged off-DRAM, depending on the desired accuracy.

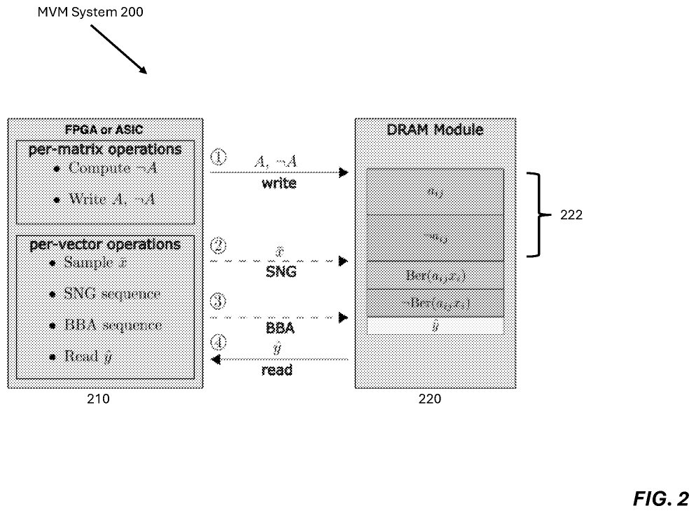

FIG. 2 shows an MVM system 200, also called a stochastic computing system, comprising a memory controller 210, potentially realized as an FPGA or an application-specific integrated circuit (ASIC), and a DRAM module 220 or set of DRAM modules. The MVM system 200 executes the four-step MVM process given above as follows. In order to obtain a sample of the estimator ŷ, the memory controller 210 is used to (1) write the elements of A and its binary negation-A to a DRAM subarray 222 in the DRAM module 220, (2) issue the command sequence for stochastic number generation (SNG) to the DRAM module 220, (3) issue the command sequence for bulk bitwise accumulation (BBA) to the DRAM module 220, and (4) read the rows containing y from the DRAM module 220. In certain applications (including Langevin sampling), a single matrix A is used repeatedly in a series of matrix-vector multiplications. In such cases, the matrix A and its negation can be written once (step 1) of the MVM process, and then steps 2 through 4 of the MVM process may be repeated as many times as desired, with a different vector x used each time. Step 1 is therefore called a per-matrix operation, and steps 2 through 4 are per-vector operations.

### Native COTS DRAM Operations

The MVM process described above uses a comparison operation and bulk bitwise accumulation operation, which are done in DRAM using a set of operations that can be performed natively in DRAM. It is also possible to perform copying, majority-of-3 gates, AND gates, and OR gates in DRAM.

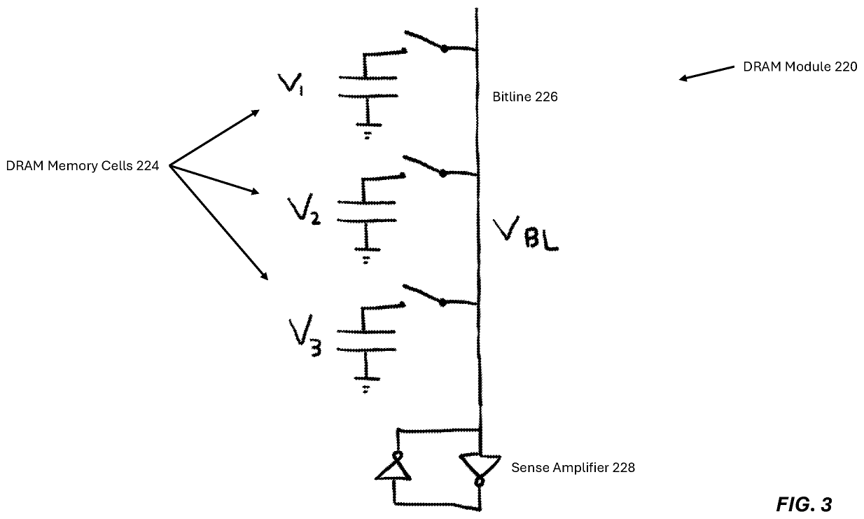

FIG. 3 illustrates details of the DRAM device 220, including three memory cells 224 connected by a bitline 226 to a sense amplifier 228. Each memory cell 224 stores data in the charge of a capacitor, each of which represents a logical 0 or 1 by a voltage of 0 or Vad, respectively. The capacitors (and memory cells 224) are organized into columns, such that each capacitor in a column is connected (via a transistor) to the same wire—the bitline 226—which is used to read and write data. The capacitors are also organized into rows, and at any given time the capacitors in a single row are either all connected to their respective bitlines, or all disconnected. This is accomplished by connecting the gate voltage of each transistor in a row to the same wire (the wordline). When the memory cells 224 in a given row are connected to their respective bitlines 226, the row is said to be active. In ordinary operation, only one row per bank is supposed to be active at any time; however, it is possible to have multiple rows active at a time if multiple ACTIVATE commands are sent in a small time interval. This generally involves violating the timing constraints set out in the specification for a DRAM module. When multiple rows are active at the same time, the data stored in each active row may change, as multiple cells share charge with the same bitline 226; and the changes that occur in such a case can be used to implement various Boolean logic operations on the data stored in DRAM cells. So, by sending illegal command sequences to the DRAM module 220 it is possible to perform computation in memory.

Typically, the DRAM device 220 does not ensure that the command sequences that it receives conform to the timing constraints in its specification. Instead, the memory controller 210, which is a separate piece of hardware, is responsible for making sure the timing constraints are followed. This includes the restriction that there should be at least a certain number of cycles between two consecutive commands, with the number of cycles depending on the consecutive commands. When the memory controller 210 does not adhere to these constraints, and issues commands that are not separated by the specified number of cycles, this causes the DRAM module 220 to behave in a different way than is described in its specification. This approach can be used to perform logical operation in a commodity DRAM chip and is sometimes called processing in commercial off-the-shelf DRAM (COTS DRAM).

A number of operations can be performed in COTS DRAM, including:
Row copy: This operation copies all bits from one row of a DRAM subarray to another row in the same subarray.
Majority of 3 (MAJ3): This operation acts on three DRAM rows. For every column, the bits in each of the input rows are overwritten by the majority operand (the value which occurs most frequently in the three input rows) for that column.
Bitwise accumulation: Bitwise accumulation is the summing of bits in each column in parallel over a specified set of input rows. A method has been demonstrated that uses a sequence of MAJ3 operations to perform bitwise accumulation. In this operation, a set of input rows is specified. In every column, the number of occurrences of 1 is counted over the set of input rows. The result is formatted as a binary number and stored in a set of designated output rows.

### Stochastic Number Generation

The MVM process described above uses a comparison operation for generating random bits that have the desired probabilities. The comparison can be done in the DRAM device, using a process described here.

The greater-than-negation operation GTNₙ evaluates a comparator on two n-bit numbers:

$${GTN}_{n} ( a , b ) = \{ 1 a > ¬ b 0 otherwise ,$$

where ¬b is the bitwise negation of b, that is, (¬b)[i]=¬(b[i]). The rows i . . . i+n−1 and j . . . j+n−1 are left unchanged by GTNₙ. To derive an implementation of GTNₙ, we first note that a>¬b if and only if there exists some i∈{1, 2, . . . n} such that
1. a [i]>¬b[i], and
2. a[j]≥¬b[j] for all j<i.

In terms of Boolean logic, these two conditions are
1. a[i]ωb[i]=1, and
2. a [j]∪b[j]=1 for all j<i.
   We therefore initialize two bits c₁₂=0 and c₂=1. We look sequentially at each bit of a and b, and if at some point condition 2 fails to be true, c₂ will be set to 0, and remain 0. Meanwhile, the bit c₁₂ will be set to 1 only once both conditions 1 and 2 have been satisfied, if they are. This can be accomplished using the following loop

c₂←1c₁₂←0GTNₙ(a,b)←c₁₂GEQNₙ(a,b)←c₁₂∪c₂

To generate a sample of a stochastic number ā, we first generate a w-bit uniform random number η, and then perform a comparison between a and η. The random number n can be generated on the DRAM device using, for example, the QUAC-TRNG method disclosed in Olgun et al., “Quac-trng: High-throughput true random number generation using quadruple row activation in commodity dram chips,” in 2021 ACM/IEEE 48th Annual International Symposium on Computer Architecture (ISCA), pages 944-957, which is incorporated herein by reference for all purposes. This yields a sample of ā.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein.

The foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of estimating a product of a matrix and a vector, the method comprising:
storing the matrix in a dynamic random access memory (DRAM);
generating, with a memory controller operably coupled to the DRAM, samples of a first set of Bernoulli random variables whose probabilities are proportional to elements of the vector;
generating, in the DRAM, samples of a second set of Bernoulli random variables whose probabilities are proportional to elements of the matrix;
copying the samples of the second set of Bernoulli random variables from a first portion of the DRAM to a second portion of the DRAM conditioned on the samples of the first set of Bernoulli random variables;
performing bulk bitwise accumulation, on the DRAM, on the second portion of the DRAM; and
reading, with the memory controller, an output of the bulk bitwise accumulation as an estimate of the product of the matrix and the vector.

2. The method of claim 1, wherein estimating the product of the matrix and vector occurs without writing the vector to the DRAM.

3. The method of claim 1, wherein storing the matrix comprises storing a first column of the matrix in a first column of the DRAM.

4. The method of claim 1, wherein generating the second set of Bernoulli random variables comprises comparing a binary representation of the elements of the matrix to a set of unbiased random bits.

5. The method of claim 1, further comprising:
generating, with the memory controller, a binary negation of the matrix; and
storing a binary negation of the matrix in the DRAM,
wherein performing the bulk bitwise accumulation is based on both the matrix and binary negation of the matrix.

6. The method of claim 1, wherein the estimate of the product of the matrix and the vector is a first estimate, and further comprising:
generating, with the memory controller operably coupled to the DRAM, samples of a third set of Bernoulli random variables whose probabilities are proportional to elements of the vector;
generating, in the DRAM, samples of a fourth set of Bernoulli random variables whose probabilities are proportional to elements of the matrix;
copying the samples of the fourth set of Bernoulli random variables from one portion of the DRAM to another portion of the DRAM conditioned on the samples of the first set of Bernoulli random variables;
performing bulk bitwise accumulation, on the DRAM, on the other portion of the DRAM; and
reading, with the memory controller, an output of the bulk bitwise accumulation as a second estimate of the product of the matrix and the vector.

7. The method of claim 1, wherein the vector is a first vector, and further comprising:
estimating a product of the matrix and a second vector without copying the second vector to the DRAM.

8. The method of claim 7, wherein estimating the product of the matrix and the second vector comprises:
generating, with the memory controller, samples of a third set of Bernoulli random variables whose probabilities are proportional to elements of the second vector;
generating, in the DRAM, samples of a fourth set of Bernoulli random variables whose probabilities are proportional to elements of the matrix;
copying the samples of the fourth set of Bernoulli random variables from one portion of the DRAM to another portion of the DRAM conditioned on the samples of the third set of Bernoulli random variables;
performing bulk bitwise accumulation, on the DRAM, on the other portion of the DRAM; and
reading, with the memory controller, an output of the bulk bitwise accumulation as an estimate of the product of the matrix and the second vector.

9. The method of claim 1, further comprising:
performing a nonlinear operation on the product of the matrix and the vector.

10. A stochastic computing system for estimating a product of a matrix and a vector, the stochastic computing system comprising:
dynamic random access memory (DRAM) to store the matrix and to generate samples of a first set of Bernoulli random variables whose probabilities are proportional to elements of the matrix; and
a memory controller, operably coupled to the DRAM, to generate samples of a second set of Bernoulli random variables whose probabilities are proportional to elements of the vector, to instruct the DRAM to copy the samples of the first set of Bernoulli random variables from a first portion of the DRAM to a second portion of the DRAM conditioned on the samples of the second set of Bernoulli random variables, to instruct the DRAM to perform bulk bitwise accumulation on the second portion of the DRAM, and to read an output of the bulk bitwise accumulation as an estimate of the product of the matrix and the vector.

11. The stochastic computing system of claim 10, wherein the stochastic computing system is configured to estimate the product of the matrix and vector without writing the vector to the DRAM.

12. The stochastic computing system of claim 10, wherein the memory controller is configured to generate a negation of the matrix and to load the negation of the matrix into the DRAM.

13. The stochastic computing system of claim 12, wherein the DRAM is configured to perform the bulk bitwise accumulation based at least in part on the negation of the matrix.

14. The stochastic computing system of claim 10, wherein the memory controller is configured to perform a nonlinear operation on the estimate of the product of the matrix and the vector.

15. The stochastic computing system of claim 10, wherein the DRAM is configured to perform high-throughput accumulation.

16. The stochastic computing system of claim 10, wherein the DRAM is configured to store a first column of the matrix in a first column of memory cells.

17. The stochastic computing system of claim 10, wherein the DRAM is configured to generate the first set of Bernoulli random variables by comparing a binary representation of the elements of the matrix to a set of unbiased random bits.

18. The stochastic computing system of claim 10, wherein the stochastic computing system is configured to generate and average multiple estimates of the product of the matrix and the vector.

19. The stochastic computing system of claim 10, wherein the vector is a first vector and the stochastic computing system is configured to estimate a product of the matrix and a second vector without copying the second vector to the DRAM.

20. The stochastic computing system of claim 19, wherein:
the DRAM is configured to generate samples of a third set of Bernoulli random variables whose probabilities are proportional to elements of the matrix, and
the memory controller is configured to generate samples of a fourth set of Bernoulli random variables whose probabilities are proportional to elements of the second vector, to instruct the DRAM to copy the samples of the third set of Bernoulli random variables from one portion of the DRAM to another portion of the DRAM conditioned on the samples of the fourth set of Bernoulli random variables, to perform bulk bitwise accumulation on the other portion of the DRAM, and to read an output of the bulk bitwise accumulation as an estimate of the product of the matrix and the second vector.
